(19) United States
(12) Patent Application Publication
(10) Pub. No.: US 2009/0099720 A1
(43) Pub. Date: Apr. 16, 2009

(54) MONITORING THE OPERATION AND MAINTENANCE OF VEHICLES

(76) Inventor: Mordechai ELGALI, D.N Ayalon (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/872,736

(22) Filed: Oct. 16, 2007

(51) Int. Cl. G01M 17/00; G06Q 10/00

(52) U.S. Cl. 701/29; 705/8

(57) ABSTRACT

A system for monitoring the operation and maintenance of vehicles. The system comprises a plurality of sensors attached to various vehicle modules that need to be monitored. The sensors are operatively connected to a control module, which in turn is operatively connected to a scheduler and to a communication module. Upon operation, the sensors present the control module with indicators relating the current operation of various modules of a vehicle. The scheduler presents the control module with user-defined schedule of operation and maintenance of said vehicle. The control module performs a matching between the schedule and the sensor indicators and alerts the user via the communication module of any mismatch between the indicators relating the current operation of various modules of a vehicle and said user-defined schedule of operation and maintenance of said vehicle.

### FIELD OF THE INVENTION

The invention relates to monitoring systems, more particularly, monitoring systems for use in vehicles.

### BACKGROUND OF THE INVENTION

Managing the operation and maintenance of a large vehicles fleet is a demanding task. Each and every vehicle, be it a car, truck, bulldozer or any mobile heavy machine has its own operation and maintenance schedule. The operation schedule is the sequence of required actions that has to be performed in order to comply with the requirements of a specific project. The maintenance schedule comprises, on the other hand, the routine actions that need to be performed in order to comply with the ongoing maintenance process of each and every vehicle.

More often than not, problems related to operation and maintenance of vehicles are detected in a stage that is beyond prevention of the damage. For instance, some sensors may alert a user of a high temperature of the engine or lack of brake fluids, oils and the like. These alerts are brought to the attention of the user (the driver or the operation officer) when damage has already started to take place and are therefore non-preventing alerts.

It would be advantageous to have a system that is able to detect the conditions that precede the situation where damage may be caused to the vehicle, as well as conditions that infer of a misuse of a vehicle.

### SUMMARY OF THE INVENTION

The present invention takes a different and unique approach for preventing damage to and misuse of vehicles. Instead of providing indicators relating to the condition of the vehicle modules at any given time, the actions of the driver in conjunction with the said vehicle modules are the actions that are monitored. If, for instance, a certain oil gauge has to be checked once a week, the system according to the present invention is capable of detecting whether the said gauge has been checked, and in the case it hasn't—provides the user with a corresponding alert. This will allow the operation officer (or safety inspector) to be informed, well in advance, of a condition non-complying with the maintenance process, and act accordingly.

In addition, the present invention enables an automatic alert whenever a misuse of the vehicle is taking place. In the case of a mobile heavy machine. Taking the heavy machine of a truck and operating it elsewhere will be reported as it is non complying with the operation schedule of said vehicle.

In embodiment, the system comprises a plurality of sensors attached to various vehicle modules that need to be monitored. The sensors are operatively connected to a control module, which in turn is operatively connected to a scheduler and to a communication module. Upon operation, the sensors present the control module with indicators relating the current operation of various modules of a vehicle. The scheduler presents the control module with user-defined schedule of operation and maintenance of said vehicle. The control module performs a matching between the schedule and the sensor indicators and alerts the user via the communication module of any mismatch between the indicators relating the current operation of various modules of a vehicle and said user-defined schedule of operation and maintenance of said vehicle.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 illustrates a block diagram of the system according to the present invention;

FIG. 2 illustrates a flow chart showing the steps of the method according to the present invention.

The drawings together with the description make apparent to those skilled in the art how the invention may he embodied in practice.

Further, where considered appropriate, reference numerals may be repeated among the figures to indicate corresponding or analogous elements.

### DETAILED DESCRIPTION OF THE INVENTION

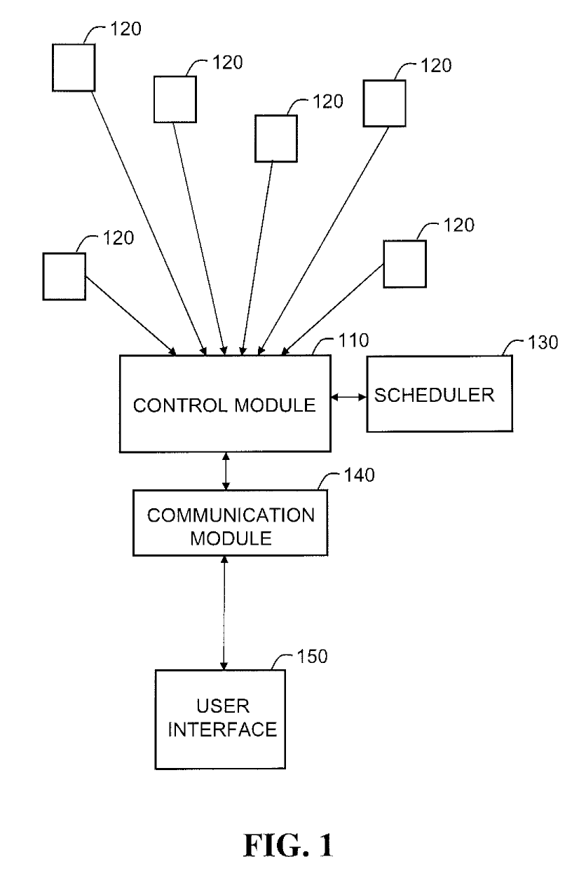

FIG. 1 shows the system for monitoring the operation and maintenance of vehicles. The system comprises a plurality of sensors 120 attached to various vehicle modules that need to be monitored. The sensors 120 are operatively connected to a control module 110, which in turn is operatively connected to a scheduler 130 and to a communication module 140. Upon operation, the sensors present the control module with indicators relating the current operation of various modules of a vehicle. Specifically, the vehicle modules are associated with operation controls and maintenance indicators. These modules are component that are used in order to change the configuration of the vehicle or the mobile machine and/or perform maintenance activities. The scheduler 130 presents the control module 110 with user-defined schedule of operation and maintenance of said vehicle. The control module 110 performs a matching between the schedule and the sensor indicators and alerts the user via the communication module 140 of any mismatch between the indicators relating the current operation of various modules of a vehicle and said user-defined schedule of operation and maintenance of said vehicle.

According to some embodiments of the invention, the sensors are of at least one of the following: micro-switch, proximity sensor, volume sensor, movement sensor. These sensors are configured to detect the use and operation of the certain modules of the vehicle, (covers, lids, gauges) that are associated with maintenance and operation apart from driving the vehicle.

According to some embodiments of the invention, the communication module delivers the alert to the user over a user interface module. The user is which is the object of alert may be the driver himself or herself, but also the maintenance officer the operation officer, the safety inspector and any person, or automated system that takes part at the operational management of the vehicles fleet.

According to some embodiments of the invention, the user interface module may be in the form of a personal computer, a mobile phone, a dedicated hardware module, a portable device accessory. Thus any way of displaying or other means of directing the attention of the user may be covered. Specifically, the alert may be transferred via a cellular network, a wireless network, the Internet, a wired network and the like.

According to some embodiments of the invention, the user defined operation schedule comprises the required actions of a specific vehicle that have to be performed in conjunction with a timetable in order to comply with a project requirements.

According to some embodiments of the invention, the user defined maintenance schedule comprises the required actions of a specific vehicle that have to be performed in conjunction with a timetable in order to comply with the maintenance requirements.

According to some embodiments of the invention, the alert is in at least one of the following forms: SMS, GPRS, RSS feed, beeper alert, email and the like.

According to some embodiments of the invention, the alert data is transmitted to a remote computer or server that accumulates the alert data from each and every vehicle. Then, any user may connect to said computer or server and retain relevant data upon identification. In addition, said computer or server is configured to produce maintenance and operation reports on demand.

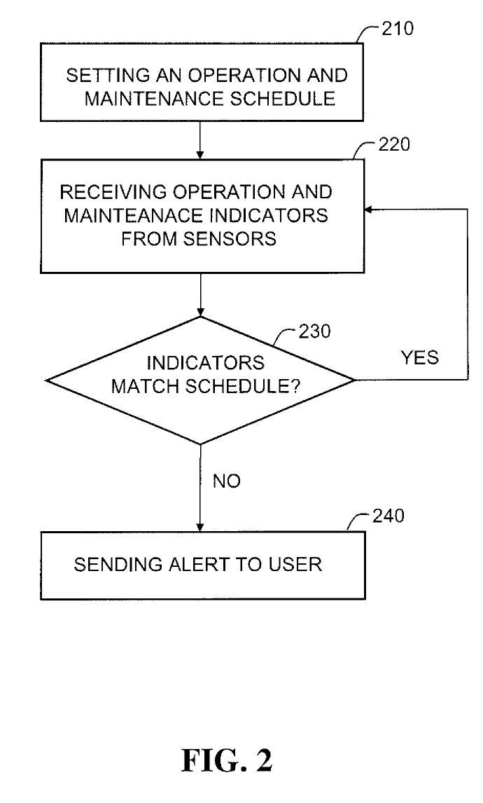

FIG. 2 illustrates a flow chart showing the steps of the method according to the present invention. The method for monitoring the operation and maintenance of vehicles comprises the steps of: setting an operation and maintenance schedule for at least one vehicle 210; detecting actions in relation to operation and maintenance of said vehicle 220; checking whether there is a mismatch between the detected actions and the user defined schedule 230; and alerting the user in case there is such a mismatch 240.

According to some embodiments of the invention, the setting an operation and maintenance schedule for at least one vehicle is performed automatically by deriving the schedule from the main computers system of the vehicles operation company.

According to some embodiments of the invention, detecting actions in relation to operation and maintenance of said vehicle is derived from operation and lack thereof id vehicle modules that are required for vehicle operation and maintenance.

According to some embodiments of the invention, alerting a user in case of a mismatch between said schedule and detected actions is performed via at least one of the following means: a cellular network, a wired network, a wireless network, the Internet.

Advantageously, the present invention is used not only for tracking the driver or the operator of the mobile machine. By sending at least some of the alerts to the driver or operator, the non-compliance with the schedule gives him or her to take the required actions immediately, thus preventing the damage before it has occurred.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A system for monitoring the operation and maintenance of vehicles, said system comprising:
a plurality of sensors attached to vehicle modules and operatively connected to
a control module; operatively connected to
a scheduler; and
a communication module operatively connected to said control module;
wherein the sensors present the control module with indicators relating the current operation of various modules of a vehicle;
and wherein the scheduler presents the control module with user-defined schedule of operation and maintenance of said vehicle;
and wherein the control module alerts the user via the communication module of any mismatch between the indicators relating the current operation of various modules of a vehicle and said user-defined schedule of operation and maintenance of said vehicle.

2. The system of claim 1, wherein the sensors are of at least one of the following: micro-switch, proximity sensor, volume sensor, movement sensor.

3. The system of claim 1, wherein the communication module delivers the alert to the user over a user interface module.

4. The system of claim 1, wherein the user is at least one of the following: the driver, the maintenance officer, the operation officer, the safety inspector.

5. The system of claim 3, wherein the user interface module is at least one of the following: a personal computer, a mobile phone, a dedicated hardware module, a portable device accessory.

6. The system of claim 3, wherein the communication module delivers the alert over at least one of the following means: a cellular network, wireless network, the Internet, wired network.

7. The system of claim 1, wherein the user defined operation schedule comprises the required actions of a specific vehicle that have to be performed in conjunction with a timetable in order to comply with a project requirements.

8. The system of claim 1, wherein the user defined maintenance schedule comprises the required actions of a specific vehicle that have to be performed in conjunction with a timetable in order to comply with the maintenance requirements.

9. The system of claim 3 wherein the alert is in at least one of the following forms: SMS, GPRS, RSS feed, beeper alert, email.

10. The system of claim 3 wherein the control module is further configured to accumulate the alert data from each and every vehicle and is further configured to enable a user, upon identification, to retrieve alert data relevant to specific vehicles.

11. A method for monitoring the operation and maintenance of vehicles, said system comprising the steps of:
setting an operation and maintenance schedule for at least one vehicle;
detecting actions in relation to operation and maintenance of said vehicle;
alerting a user in case of a mismatch between said schedule and detected actions.

12. The method of claim 11 wherein the setting an operation and maintenance schedule for at least one vehicle is performed automatically by deriving the schedule from the main computers system of the vehicles operation company.

13. The method of claim 11, wherein detecting actions in relation to operation and maintenance of said vehicle is derived from operation and lack thereof id vehicle modules that are required for vehicle operation and maintenance.

14. The method of claim 11, wherein alerting a user in case of a mismatch between said schedule and detected actions is performed via at least one of the following means: a cellular network, a wired network, a wireless network, the Internet.

15. The method of claim 11, further comprising the step of generating reports regarding the operation and maintenance of said vehicles.

16. A system for monitoring the operation and maintenance of vehicles, said system comprising:
means for setting an operation and maintenance schedule for at least one vehicle;
means for detecting actions in relation to operation and maintenance of said vehicle;
means for alerting a user in case of a mismatch between said schedule and detected actions.

17. The system of claim 16 wherein the means for setting an operation and maintenance schedule for at least one vehicle is operated automatically by driving the schedule from the main computers system of the vehicles operation company.

18. The system of claim 16, wherein the means for detecting actions in relation to operation and maintenance of said vehicle is derived from operation and lack thereof of vehicle modules that are required for vehicle operation and maintenance.

19. The system of claim 16, wherein alerting a user in case of a mismatch between said schedule and detected actions is performed via at least one of the following means: a cellular network, a wired network, a wireless network, the Internet.
